(19) United States
(12) Patent Application Publication
(10) Pub. No.: US 2025/0333358 A1
(43) Pub. Date: Oct. 30, 2025

(54) ECO-FRIENDLY CONCRETE AND SOIL CEMENT UTILIZING WASTE PRODUCTS

(71) Applicant: IDAHO STATE UNIVERSITY, POCATELLO, ID (US)

(72) Inventors: Mustafa Mashal, POCATELLO, ID (US); James Mahar, POCATELLO, ID (US); Kunal Mondal, KNOXVILLE, TN (US); Kabiraj Phuyal, BOISE, ID (US)

(21) Appl. No.: 19/188,726

(22) Filed: Apr. 24, 2025

Related U.S. Application Data
(60) Provisional application No. 63/638,006, filed on Apr. 24, 2024.

(51) Int. Cl. C04B 18/24; C04B 14/00; C04B 14/28; C04B 14/36; C04B 18/02; C04B 28/02

(52) U.S. Cl. CPC C04B 18/248; C04B 14/005; C04B 14/28; C04B 14/361; C04B 18/02; C04B 28/02; C04B 2201/50

(57) ABSTRACT

A precipitated calcium carbonate derived from plant matter may be used in place of or in combination with cementitious materials in various products and methods of making such products. The product may be a concrete comprising water and an aggregate in addition to the precipitated calcium carbonate derived from plant matter. The product may also be a soil cement comprising soil in addition to the precipitated calcium carbonate derived from plant matter.

### CROSS-REFERENCE TO RELATED APPLICATIONS

This application claims benefit of the filing date of U.S. Provisional Patent Application Ser. No. 63/638,006, having a filing date of Apr. 24, 2024, which is incorporated herein by reference for all purposes.

### FIELD

The present subject matter relates generally to cementitious materials, products made from such materials, and methods of making such products, and more particularly to cementitious materials wherein at least a portion of the material includes precipitated calcium carbonate derived from plant matter.

### BACKGROUND

Concrete is the second-most consumed material globally after water. Every year twenty billion tons of raw materials are used for concrete. Cement production generates about seven to eight percent of global anthropogenic carbon dioxide (CO₂) emissions. For each ton of Portland cement produced, nearly nine tenths (0.9) ton of CO₂ emissions are generated.

Accordingly, alternative materials which may be used in place of Portland cement would be desired in the art. For example, reducing the usage of Portland cement in products such as concrete, soil cement, or other products made from cementitious materials would reduce the carbon footprint of such products. In particular, replacing some or all of the Portland cement with materials that might otherwise be disposed of, e.g., in a landfill, or materials which are renewable such as plant-based materials, would be beneficial.

### BRIEF DESCRIPTION

Aspects and advantages of the invention will be set forth in part in the following description, or may be apparent from the description, or may be learned through practice of the invention.

In one exemplary embodiment, a concrete is provided. The concrete includes a cementitious material. The cementitious material includes a cement and precipitated calcium carbonate derived from plant matter. The concrete further includes water and an aggregate.

In another exemplary embodiment, a soil cement is provided. The soil cement includes soil and a cementitious material. The cementitious material includes precipitated calcium carbonate derived from plant matter.

In a further exemplary embodiment, a method of preparing a product comprising cementitious material is provided. The method includes mixing the cementitious material with an aggregate to form a mixture. The cementitious material includes precipitated calcium carbonate derived from plant matter. The method further includes curing the mixture. Curing the mixture includes a hydration reaction of the cementitious material. As a result of curing the mixture, the product is formed.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a graph of twenty eight day compressive strength for various exemplary concrete products according to one or more embodiments of the present subject matter.

FIG. 2 provides a graph of tensile strength for various exemplary concrete products according to one or more embodiments of the present subject matter.

FIG. 3 provides a graph of flexural strength for various exemplary concrete products according to one or more embodiments of the present subject matter.

FIG. 4 provides a graph of twenty eight day compressive strength for various exemplary concrete products according to one or more additional embodiments of the present subject matter.

FIG. 5 provides a graph of tensile strength for various exemplary concrete products according to one or more additional embodiments of the present subject matter.

FIG. 6 provides a graph of flexural strength for various exemplary concrete products according to one or more additional embodiments of the present subject matter.

FIG. 7 provides a graph of twenty eight day compressive strength for various exemplary concrete products according to one or more further embodiments of the present subject matter.

FIG. 8 provides a graph of tensile strength for various exemplary concrete products according to one or more further embodiments of the present subject matter.

FIG. 9 provides a graph of flexural strength for various exemplary concrete products according to one or more further embodiments of the present subject matter.

FIG. 10 provides a graph of compressive strength for various exemplary soil cement products according to one or more embodiments of the present subject matter.

FIG. 11 provides a graph of compressive strength for various exemplary soil cement products according to one or more additional embodiments of the present subject matter.

FIG. 12 provides a flow chart of an exemplary method of preparing a product comprising cementitious material according to one or more embodiments of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees either clockwise or counterclockwise with the vertical direction V.

The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components.

The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of the present disclosure include cementitious materials, products made from such materials, and methods of making such products. Disclosed herein are cementitious materials which may be used in products such as concrete or soil cement. For example, materials according to the present disclosure may be used in conventional concrete, ready mix, pre-cast, shotcrete, and various other forms.

In general, a concrete mixture comprises cementitious material and aggregate, e.g., fine aggregate (e.g., sand) or coarse aggregate (e.g., rocks or gravel). In forming the concrete, the cementitious material is mixed with water to initiate a hydration reaction which, over time, releases heat, binds or confines the water, and ultimately dries and hardens to form a finished product which may be used in various structures or materials (the overall process of mixing the cement with water and then allowing the hydration reactions to carry out until a dry, solid product is formed is generally referred to as setting or curing). A concrete mixture may also include other materials such as supplementary cementitious materials or admixtures.

A soil cement similarly includes cementitious material, where the cementitious material is mixed with native soil, e.g., in situ, and then cured. Soil cement may be used for improving the soil. Improving the soil may include, for example, increasing the mechanical strength of the soil, which may be useful in slope stabilization, as a subgrade for a road, to support a building foundation, or other purposes. The cementitious material according to the present disclosure may be used in such concrete mixtures, soil cement, and other similar applications.

The water which is incorporated into mixes according to the present disclosure may include a variety of types of water from a variety of sources. For example, the water may be potable water or otherwise treated water. Also by way of example, the water may be recycled water, gray water, collected runoff, or wastewater. Wastewater may be derived from municipal and/or industrial sources, such as the wastewater may be or may include process water. In various embodiments, any one or more of such water types or combinations thereof may be included.

The cementitious material according to the present disclosure includes Precipitated Calcium Carbonate (PCC) derived from plant matter, such as sugar beets. The PCC may also be referred to as Carbonation Lime Residue (CLR). As mentioned, the PCC may be derived from plant matter. For example, byproducts and wastes from beet sugar production may include a lime sludge. The lime sludge may be settled and the precipitate generated thereby may provide PCC for cement products, such as cementitious material which may be used in, for example, concrete or soil-cement. As another example, sugarcane bagasse ash produced from cane sugar can also be used to replace a portion of cement in concrete and like products. Cement and related products (e.g., concrete, soil cement, and the like) which include components derived from sugar manufacturing, such as the PCC described herein, may also be referred to as sweetcrete.

PCC according to the present disclosure, e.g., which is derived from plant matter, may include a high concentration of calcium carbonate (CaCO₃), and such concentration may indicate the binding capacity in PCC. The second most prevalent constituent in the PCC may be quartz (SiO₂). The concentrations of calcium carbonate and quartz may be measured or determined, for example, using X-ray Diffraction (XRD) to analyze the crystallographic structure of the material. For example, the elemental composition of the PCC may include between about 25% and about 55% oxygen by weight, such as between about 30% and about 50% oxygen by weight, such as between about 35% and about 45% oxygen by weight, such as about 40% oxygen by weight, such as 39.4% oxygen by weight. Also by way of example, the elemental composition of the PCC may include between about 30% and about 60% calcium by weight, such as between about 35% and about 55% calcium by weight, such as between about 40% and about 50% calcium by weight, such as about 45% calcium by weight, such as 45.9% calcium by weight. Further by way of example, the elemental composition of the PCC may include between about 2% and about 20% carbon by weight, such as between about 5% and about 15% carbon by weight, such as about 10% carbon by weight, such as 9.2% carbon by weight. For example, such composition of the PCC may be measured or determined using known techniques such as X-ray diffraction analysis (XRD), scanning electron microscopy (SEM), or energy dispersive X-ray spectrometry. The PCC may be in powder or granular form with particle sizes up to about 1 in., such as up to about 0.5 in. Such PCC may also be characterized by an irregular, sub-angular to sub-rounded morphology, e.g., which may be identified using scanning electron microscopy. Further, it is to be understood that precipitated calcium carbonate derived from plant matter is distinct from other types of precipitated calcium carbonate, e.g., rock-derived materials, such as marble powder from carbonate rocks.

Referring again to the example of a concrete mixture, the concrete mixture may include a hydraulic cement, e.g., Portland cement. Portland cement may be manufactured by, e.g., crushing, milling and proportioning the following materials: lime or calcium oxide (CaO, such as from limestone, chalk, shells, shale or calcareous rock), silica (SiO₂, e.g., from sand, old bottles, clay or argillaceous rock); alumina (Al₂O₃, e.g., from bauxite, recycled aluminum, or clay); iron oxide (Fe₂O₃, e.g., from clay, iron ore, scrap iron, or fly ash); and gypsum (CaSO₄·2H₂O, which may be found together with limestone). Such materials, without the gypsum, are proportioned to produce a mixture with the desired chemical composition and then ground and blended by one of two processes-dry process or wet process. The materials are then fed through a kiln at high temperatures (e.g., about 2,600° F.) to produce grayish-black pellets known as clinker. The alumina and iron act as fluxing agents which lower the melting point of silica, e.g., from about 3,000° F. to about 2,600° F. After this stage, the clinker is cooled and pulverized, and the gypsum is added to regulate setting time. The mixture is then ground extremely fine to produce cement. Hydraulic cement derives its strength from chemical reactions between the cement and water, which process is referred to as hydration. Hydration of hydraulic cement into secondary components provides strength to the resulting concrete according to the known chemical reactions during hydration.

Cement hydration includes a series of reactions over a plurality of stages. Such stages include, in chronological order, an initial mixing reaction, dormancy, strength acceleration, speed reduction, and steady development. The initial mixing reaction occurs upon adding water to cement, whereupon the cement particles dissolve. The dissolved particles release ions and initiate the formation of hydration products. This phase starts the chemical process for subsequent reactions to occur. The dormancy stage, where the hydration process may appear to stall, follows the initial reaction. During the dormancy stage, further chemical reactions of the hydration process continue, albeit at a slower pace than the initial mixing reaction. During the strength acceleration stage, the hydration process occurs more rapidly and there is a noticeable increase in strength development. Hydration products like the calcium silicate hydrate (C—S—H) gel and calcium hydroxide (CH) begin to form more extensively, enhancing the strength of the material. Once the initial acceleration in strength development occurs, the rate of reaction gradually decreases, i.e., the hydration process continues but with a slowing down of the chemical reactions, hence the speed reduction stage. The final phase is the steady development stage, during which the process continues with steady and continuous development. Accordingly, the strength of the cement or concrete, in particular the compressive strength, generally increases along an asymptotic curve. The speed reduction stage generally occurs after around twenty eight days of curing time. For example, cement typically achieves about 90% to 95% or more of its ultimate strength at or about twenty eight days of curing. Thus, as will be discussed further below, strength testing is usually performed at intervals within the twenty-eight day time period after initial mixing, up to and including at day twenty eight.

As mentioned, the concrete mixture may further include aggregates, such as coarse or fine aggregates. The type and quantity of aggregate may be selected based on the desired properties for the end use of the concrete. For example, a fine aggregate such as sand may be used in concrete for sidewalks. As another example, concrete for structural uses, such as in a wall, column, or other similar structural element, may include coarse aggregates, e.g., gravel, as well as or instead of fine aggregates.

The aggregate may be or may include a Recycled Concrete Aggregate (RCA), such as remnants from demolished concrete and returned concrete from ready mix. The demolished concrete may be old concrete that has already been used for construction and return concrete may be leftover concrete from ready-mix concrete trucks. Such concrete may be recycled such as by crushing and removing unwanted materials (e.g., rebar, wood, paper, gypsum, asphalt, paint, etc.). The concrete may be crushed using crushers such as jaw-type crushers and impact crushers to reduce the size of the concrete pieces to a range which is suitable for use as aggregate in new concrete, such as coarse aggregate.

Impurities often remain in the recycled concrete after the foregoing processes. Accordingly, some recycled concrete is further treated to improve suitability for various end uses. Recycled concrete which has undergone such further treatment is typically referred to as Upcycled Concrete Aggregate (UCA). Such further treatments may include eliminating or strengthening adhered mortar, e.g., removing by grinding, heating, pre-soaking in water, or pre-soaking in acids. Other upcycling techniques to increase the strength of RCA are polymer emulsion, pozzolan slurry, calcium carbonate bio-deposition, sodium silicate solution, and carbonation. Thus, in one example, UCA may be produced by treating RCA with mild acid in a carbon capture and mineralization process.

Concrete mix designs were developed for testing, in which portions of the hydraulic cement was replaced by PCC (such portions being indicated as percentages of Portland Cement replaced by PCC in Table 1 below). Some of the concrete mix designs also included recycle aggregate, in particular UCA, in place of raw or virgin aggregates, where the portion substituted with UCA is also stated as a percentage in Table 1 below.

TABLE 1
Concrete Mix Design per Cubic Foot

| Material | Amount | |
|---|---|---|
| Water | 12.82 | lbs. |
| Portland Cement | 29.36 | lbs. |
| Fine Aggregate | 34.24 | lbs. |
| Coarse Aggregate | 69.19 | lbs. |
| Total Weight | 145.61 | lbs. |

| | |
|---|---|
| Water to Cement ratio | 0.44 |
| Cement to Aggregate ratio | 0.258 |
| PCC | 5% to 50% |
| UCA | 12.5% to 100% |

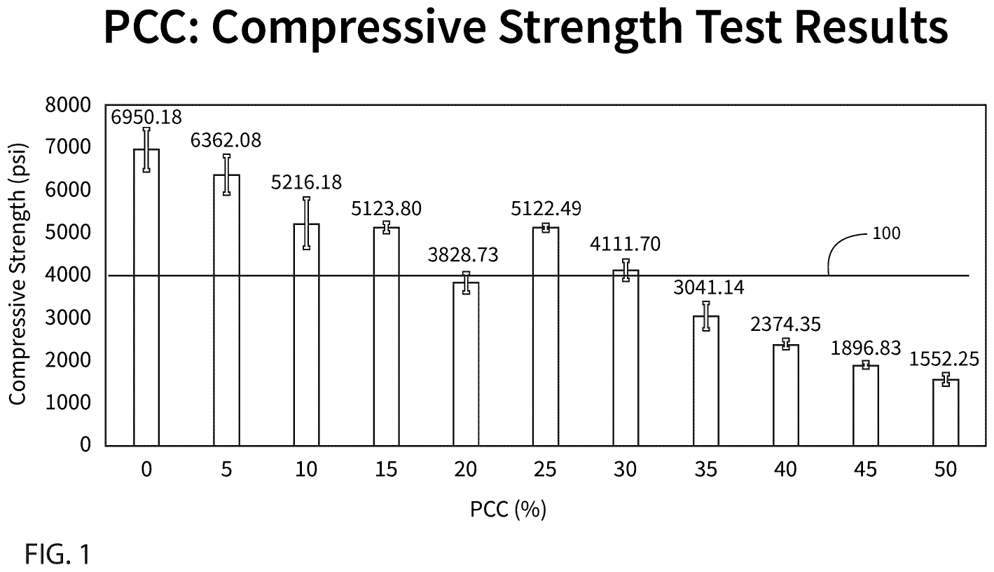

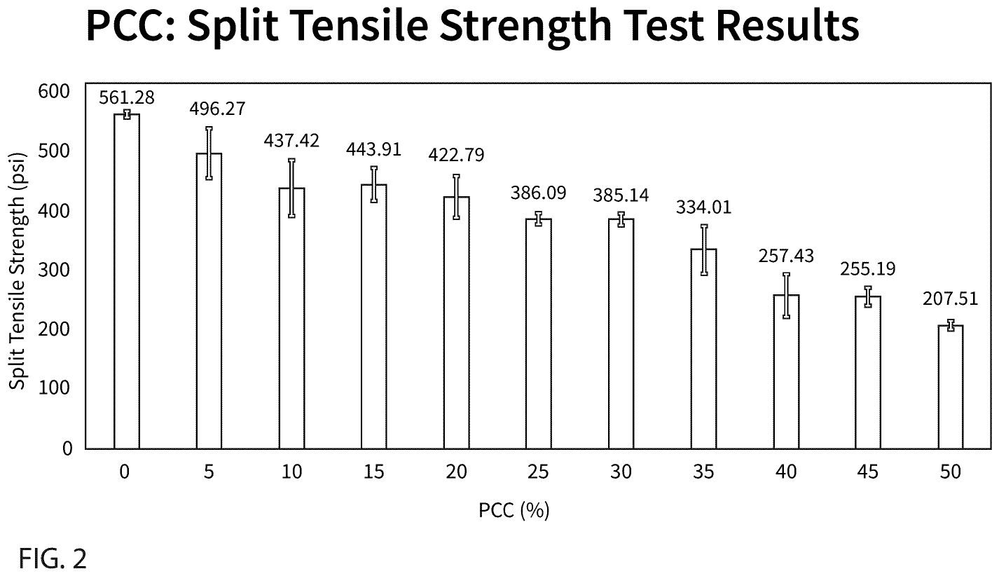

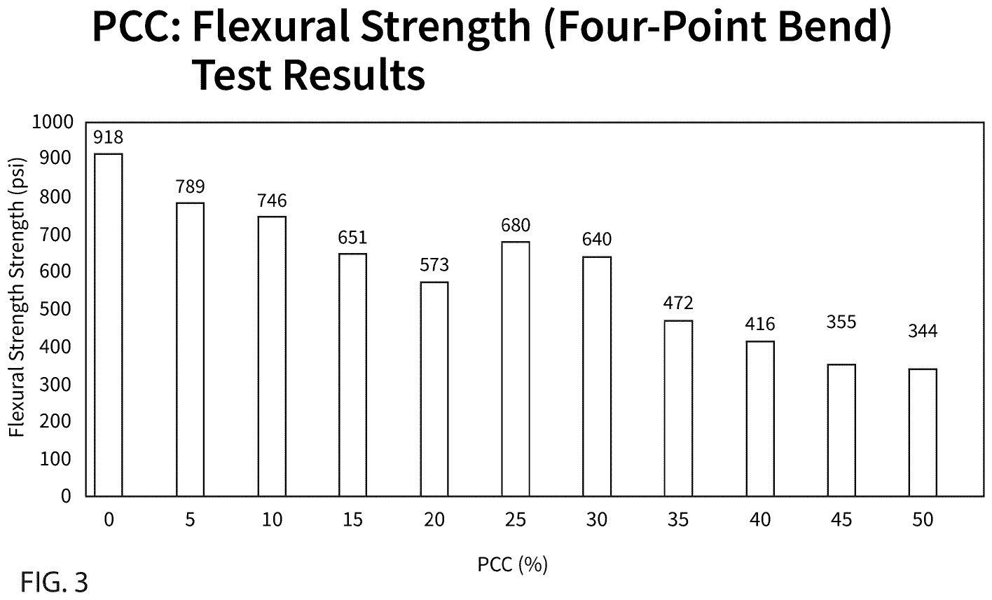

The concrete mix design described above was tested for unconfined compressive strength (FIG. 1), split tensile strength (FIG. 2), and flexural strength (FIG. 3). Compressive strength tests on concrete cylinders were performed following the standard testing protocol according to ASTM C 39, and were carried out on 4-in. diameter by 8-in. height concrete cylinders using a GILSON® Model MC-300M testing machine. Split tensile strength tests follow the ASTM C 496 standard, and were performed on standard 6 in. diameters by 12 in. height concrete cylinders, also using a GILSON® Model MC-300M testing machine. The only difference between the compressive strength test and split tensile strength test is for compressive strength, the force on the concrete cylinders is applied vertically, whereas for the split tensile strength test, the force on the 6 in. diameter by 12 in. height cylinders is applied longitudinally. The flexural strength of concrete is the indirect measure of its tensile strength and is an index of concrete quality. The flexural strength tests were carried out following ASTM C 78 (Standard Test Method for Flexural Strength of Concrete [Using Simple Beam with Third-Point Loading]).

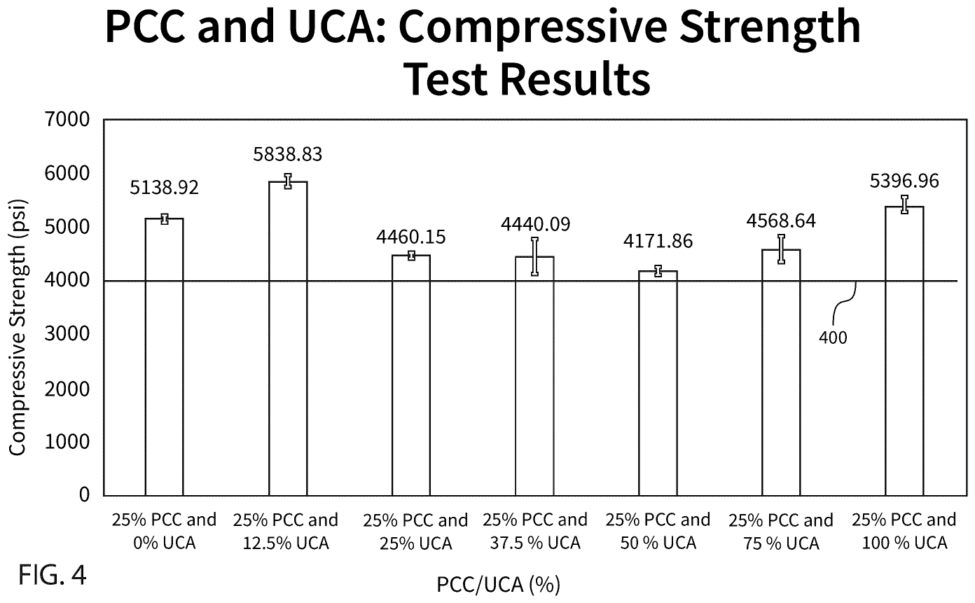

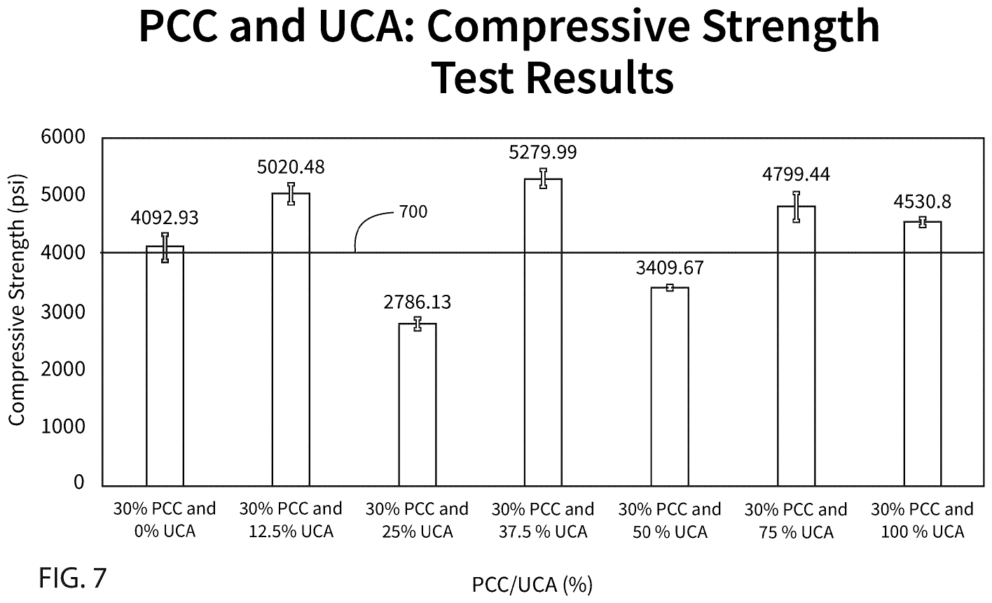

These results were compared to a benchmark conventional concrete mix with a water-to-cement ratio of 0.44. As may be seen in FIG. 1, the conventional concrete mix (i.e., with none of the cement replaced by PCC) exhibited a compressive strength of about 7,000 psi (pounds per square inch). The target compressive strength is at least about 4,000 psi, as indicated by line 100 in FIG. 1 (as well as line 400 in FIG. 4 and line 700 in FIG. 7). In general, concrete containing 0% (benchmark concrete), 5%, 10%, 15%, 25%, and 30% of Portland cement replaced by PCC attained the target strength of approximately 4,000 psi. Although the concrete with 20% PCC did not reach the target strength, this believed to be due to improper mix design, inadequate compaction, or improper gradation. Thus, as may be seen in FIG. 1, replacing up to about 25% or about 30% of the cement with PCC provides at least the target strength. The test results show a general reduction in compressive strength with increased replacement of Portland cement by PCC. However, samples with up to and including 30% PCC replacement can have compressive strength higher than the target value of 4,000 psi at 28 days.

As shown in FIG. 2, the split tensile strength of concrete with various amounts of PCC ranges from 207.51 psi to 496.27 psi. The general rule of thumb is that the split tensile strength of the concrete cylinders is 8 to 12% of the compressive strength of the concrete specimens made with the same mix. Concrete containing various percentages of PCC has tensile strengths ranging from 7.8% to 13.5% when compared to the corresponding compressive strength. The average split tensile strength of the PCC concrete was about 385 psi or more with up to and including 30% replacement. At 30% replacement, the split tensile strength was 9.4% of the corresponding compressive strength of the 30% mix which is within the 8% to 12% range of tensile to compressive strength typical for conventional concrete. From flexural strength test results (FIG. 3), it was found that the higher the amounts of cement replaced by PCC, the lower the flexural strength except for 25% and 30% cement replaced by PCC, where the difference between flexural strength of concrete with 25% cement replaced by PCC is not significantly different from the flexural strength of concrete with 30% cement replaced by PCC.

Concrete with 25% and 30% PCC were chosen for further analysis because they achieved a compressive strength greater than 4,000 psi and they can reduce carbon emissions from concrete in substantial amounts. Thus, further testing was performed on the above-referenced concrete mix (e.g., per Table 1) with 25% PCC used in combination with varying percentages of UCA, as shown in FIGS. 4, 5, and 6, and 30% PCC with varying percentages of UCA, as shown in FIGS. 7, 8, and 9.

As may be seen in FIGS. 4 and 7, compressive strength tests on concrete in which PCC replaced a portion of the cement and UCA replaced some or all the aggregate showed mixed results. For example, as shown in FIG. 4, strength tests on samples with 25% cement replaced by PCC and zero to 100% aggregate replaced by UCA had compressive strengths greater than the target strength of 4,000 psi. Turning to FIG. 7, however, it may be seen that concrete containing 30% PCC and 25% or 50% UCA had strengths much lower than 4,000 psi, although these results are believed to be anomalous, e.g., due to insufficient compaction of the test specimens.

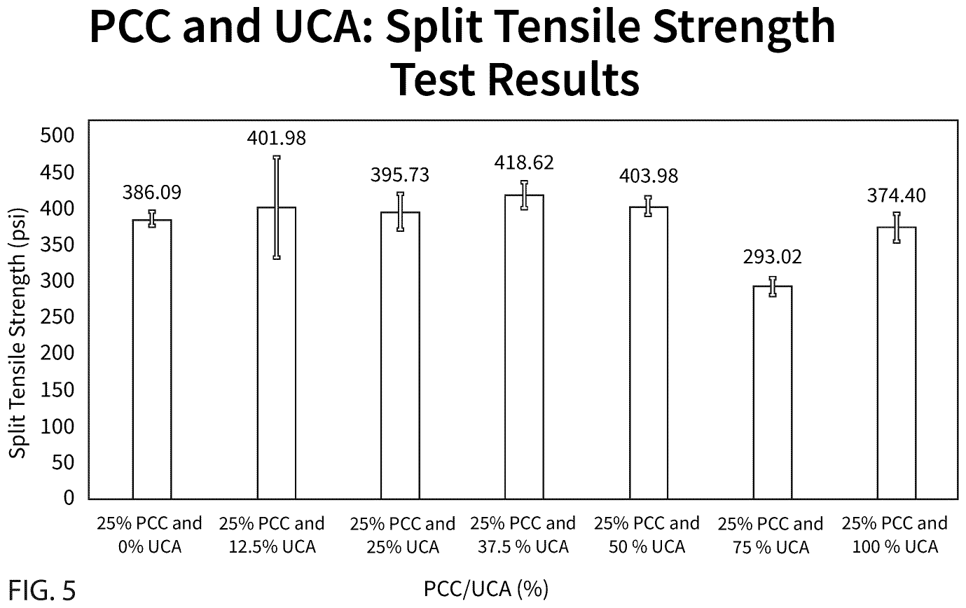

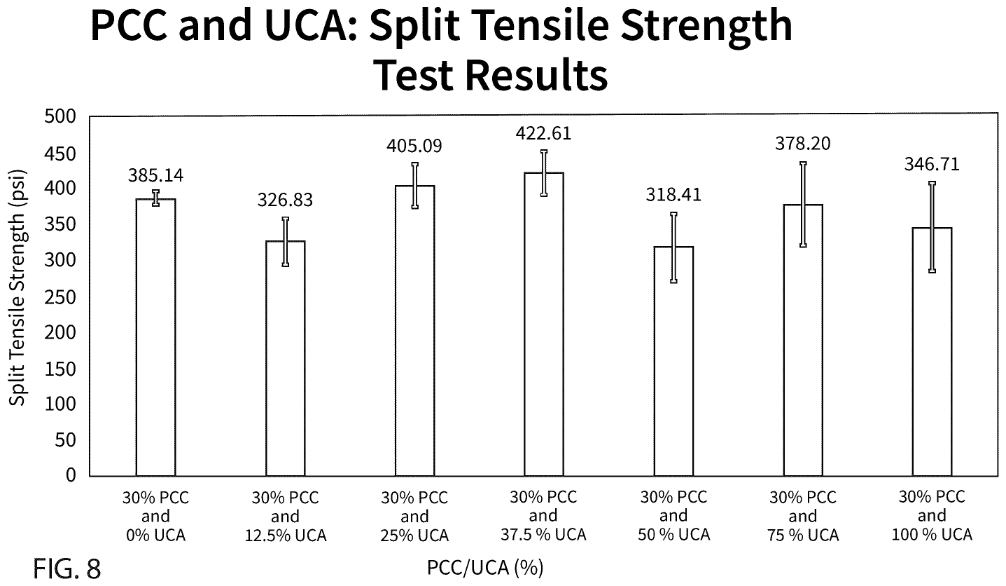

The split tensile strength for conventional (benchmark) concrete mix is a tensile strength of about 561 psi at a water to cement ratio of 0.44 (i.e., the same water to cement ratio as the test mixes, where the water to cement ratio of the test mixes is indicated in Table 1 above). As may be seen in FIG. 5, the concrete mixes including 25% PCC and varying proportions of UCA had tensile strengths within the range of about 293 psi to about 419 psi. As indicated in FIG. 8, the concrete mixes including 30% PCC and varying proportions of UCA had tensile strengths within the range of about 318 psi to about 423 psi.

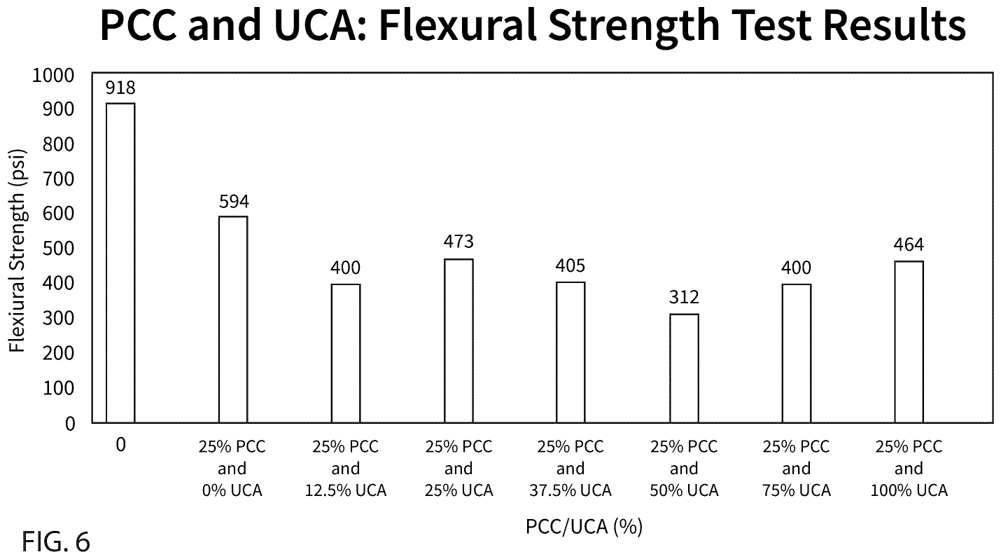

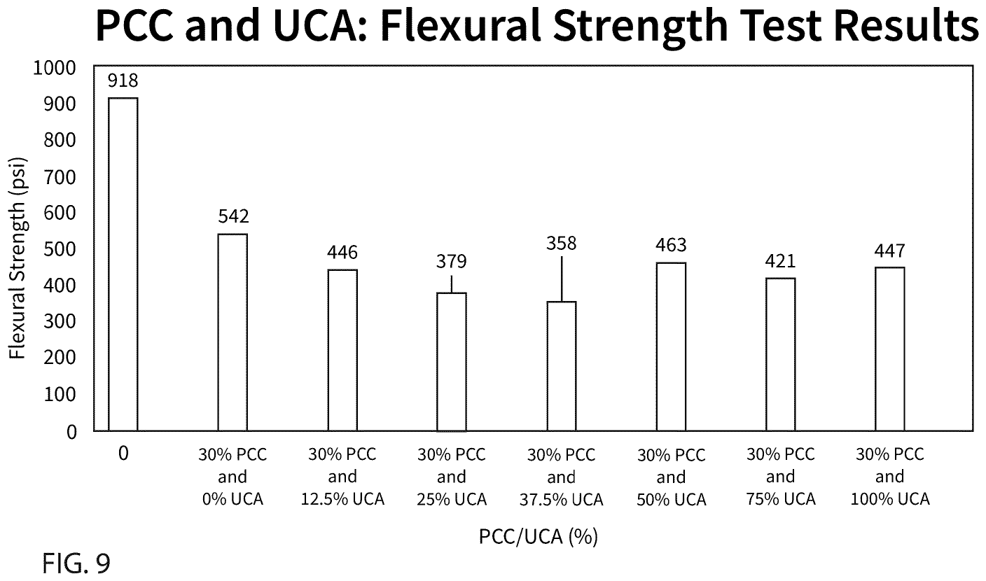

A conventional (benchmark) concrete mix may have a flexural strength of about 918 psi at a water to cement ratio of 0.44. As may be seen in FIG. 6, the concrete mixes including 25% PCC and varying proportions of UCA had flexural strengths within the range of about 293 psi to about 419 psi. As may be seen in FIG. 9, the concrete mixes including 30% PCC and varying proportions of UCA had flexural strengths within the range of about 357 psi to about 542 psi.

The testing results provided in FIGS. 1 through 9 indicate that 25% to 30% of cement can be substituted with PCC, and 0% to 100% aggregates can be replaced with UCA. Concrete mixes with these substitutions meet minimum design values in conventional concrete and have an additional benefit of reducing the carbon footprint. After reducing the substantial amounts of cement and aggregates, the production of cement and aggregates can be decreased. This has the potential to reduce the carbon dioxide emissions from both cement and aggregates.

Turning again now to the soil cement example, soil improvement by mixing with cementitious materials may include soil modification or soil stabilization. Such processes which alter the physical properties of the soil, such as a reduction in water content, to improve the engineering properties of fill while creating a stable working surface during construction may be referred to as soil modification. Adding binder material, e.g., cementitious materials which may be or may include PCC, to increase the intact strength of the soil may be referred to as soil stabilization. Soil stabilization is considered as achieved when the soil-cement mixture has cured long enough to allow the pozzolanic reactions to bind the soil particles. Cementation helps to improve compressibility, reduce permeability, and increase the durability, strength, and resistance to fracture, fatigue, and moisture of the soil, as well as to reduce swelling of the soil, where such swelling or other movements and/or changes in volume of the soil may result in settlement of overlying or adjacent structures.

Various types of soil may be candidates for improvement by cementation, e.g., forming soil cement. For example, silty soils such as loess may present difficulties in construction thereon, such as may be vulnerable to saturation collapse in subgrades beneath highway pavements. In particular, the relatively small particle size, low cohesion, and light weight of such soils may lead to movement and deposition of the soil, e.g., wind-blown silt, such that the soil is prone to undesired spontaneous displacement, e.g., settling or collapse.

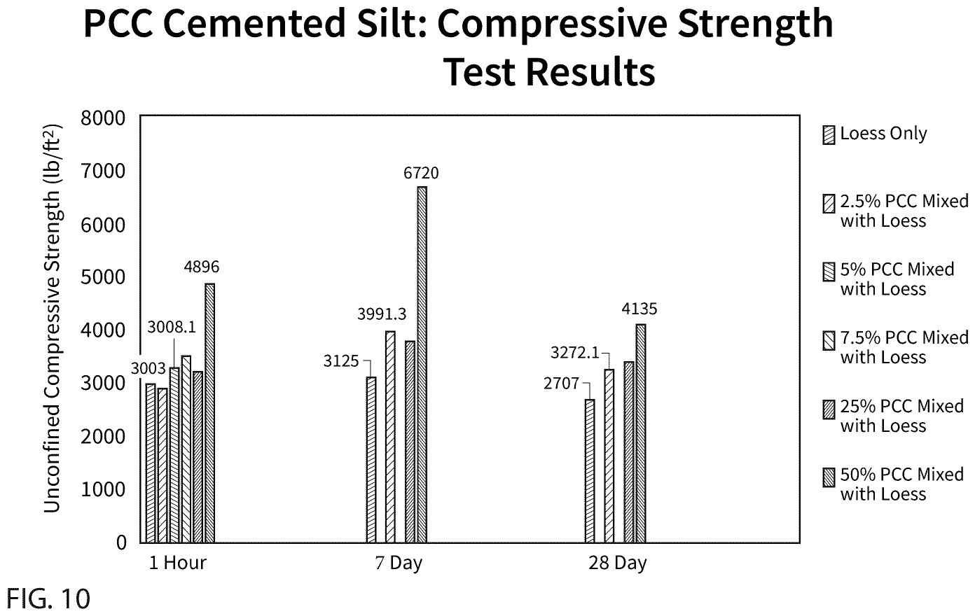

Unconfined compressive strength, also known as uniaxial compressive strength, refers to the capacity of a material to withstand axial compression forces. The unconfined compressive strength test was conducted on compacted cylindrical samples. For example, unconfined compressive strength testing has been performed on samples including wind-blown silt (loess), and wind-blown silt mixed with varying percentages of PCC, as shown in FIG. 10, to evaluate the effects of PCC on stabilizing wind-blown silt subgrades.

Various proportions of PCC at 2.5%, 5%, 7.5%, 25% and 50% by dry-weight loess were added to the loess. FIG. 10 includes results at cure times of one hour, seven days, and twenty eight days. The samples used in this test included wind-blown silt collected from the basement of Colonial Hall on the campus of Idaho State University (ISU) in Pocatello, Idaho, U.S. Colonial Hall was built in 1910 and has undergone settlement (seismically induced saturation collapse) of more than 7 in. during the past 110 years. The tests were carried out using the Durham Geo Slope E-40520 apparatus.

The experimental test results revealed a significant average increase of 10% to 28% in the strength of loess samples stabilized with 5% PCC compared to the native soil. There was a significant increase in compressive strength at 50% PCC, however, adding 50% PCC to a fill to increase the short-term (one-hour) strength may be impractical. The addition of PCC provides a significant improvement in loess resistance to saturation collapse, with a 10-28% strength increase in stabilized loess with the addition of 5% PCC by dry weight of loess.

The test results in FIG. 10 also show an increase in the 7-day compressive strength of loess containing 5% PCC (by weight). At 25% PCC the 7-day strength was higher than the loess itself but was essentially the same as with 5% PCC. Like the one-hour tests, there was a significant increase in strength at 50% PCC. There is also a notable decrease in dry unit weight with increasing amounts of PCC added, which is typically inconsistent with unit weight/strength correlations. Thus, it appears that the void ratio is higher, but the silt particles are cemented by the PCC, which is responsible for the increase in the strength.

Still referring to FIG. 10, the 28-day test results also indicate that compressive strength increases with PCC like the results with lesser curing times (1 hour and 7 days). The difference in strength between the 7-day and 28-day tests appeared to be related to the lower water content in the 28-day samples. The lower water content appears to have a significant impact on the pozzolanic effect of the PCC.

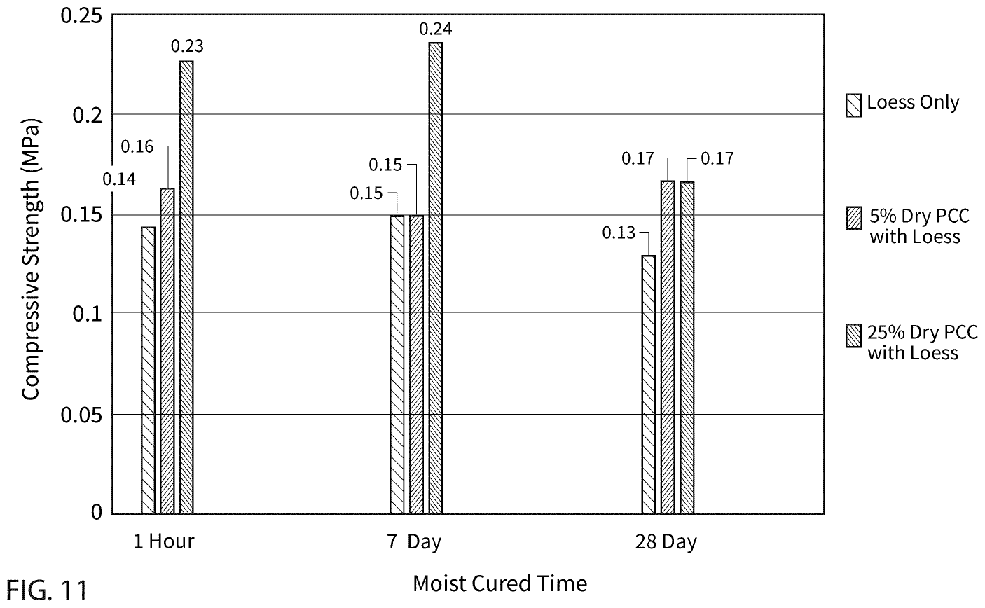

Turning now to FIGS. 11, additional studies were carried out which focused on attempting to increase the pozzolanic activity of PCC by drying and grinding. Fine powder has more surface area and is usually more reactive than coarser material. To increase the pozzolanic activity of PCC, the PCC was dried and sieved through a number 200 sieve. The proportions of dry PCC utilized for the analysis were 5%, 25%, and 50% by dry weight of loess. Like normal PCC, the dry ground PCC mixed with loess was tested after moist-curing for 1 hour, 7 days, and 28 days.

FIG. 11 displays the one-hour unconfined compressive strength test results for the dry PCC-loess mix. The highest unconfined compressive strength test results for loess were found with the addition of 25% dry ground PCC. This highest strength appears to be associated with the lower water content. The seven-day unconfined compressive strength of soil mixed with dry ground PCC was found to be greater at 25% content than at 5% (FIG. 11). The loess sample gained strength by the addition of 25% dry ground PCC at 7 days when compared to 1 hour moist-curing time. An increase in the strength of loess of about 0.091 megapascals (MPa) was observed with 25% dry ground PCC. However, the strength of PCC with the addition of 5% dry PCC fluctuated: strength decreased at 7 days and increased at 28 days. At 28 days, the unconfined compressive strength of loess with 25% dry ground PCC decreased, while loess with 5% dry ground PCC increased at 28 days when compared to 7-day test results.

As mentioned above, embodiments of the present disclosure include cementitious materials and products made from such materials. Such products include concrete products. Thus, in some particular embodiments, a concrete is provided. The concrete may include a cementitious material. The cementitious material may include a cement and precipitated calcium carbonate derived from plant matter. The concrete may further include water and an aggregate. The precipitated calcium carbonate derived from plant matter may make up about thirty percent of the cementitious material. In some embodiments, the precipitated calcium carbonate derived from plant matter may make up about thirty percent of the cementitious material or less, such as about twenty five percent or less, such as about twenty percent or less, e.g., including any of the percentages described above (e.g., about fifteen percent or less, such as about ten percent or less, such as about five percent). Thus, as compared to conventional concrete, up to about thirty percent of the cement, e.g., Portland cement, may be replaced with precipitated calcium carbonate derived from plant matter, e.g., from beet sugar waste product, such as derived from lime sludge as described above.

The precipitated calcium carbonate derived from plant matter differs from other precipitated calcium carbonate products, such as precipitated calcium carbonate from powdered rocks or precipitated calcium carbonate produced using trapped CO₂ gas, in terms of color as well as the amounts of calcium and other minerals. For example, the precipitated calcium carbonate derived from plant matter may include between about 30% and about 60% calcium by weight. The precipitated calcium carbonate comprises a powder or granular material having an irregular, sub-angular to sub-rounded morphology. Those of ordinary skill in the art will recognize that such morphology may be determined using known techniques, such as SEM.

In additional embodiments, a soil cement is provided. The soil cement includes a soil, e.g., a silty soil such as loess, although soil cement according to various embodiments of the present disclosure may be used with a variety of soil types. The soil cement may further include a cementitious material, and the cementitious material may be or may include precipitated calcium carbonate derived from plant matter. The precipitated calcium carbonate derived from plant matter in the soil cement may include any of the PCC described hereinabove, e.g., PCC derived from beet sugar lime sludge, PCC which includes a high level of calcium and/or calcium carbonate, etc., as described above.

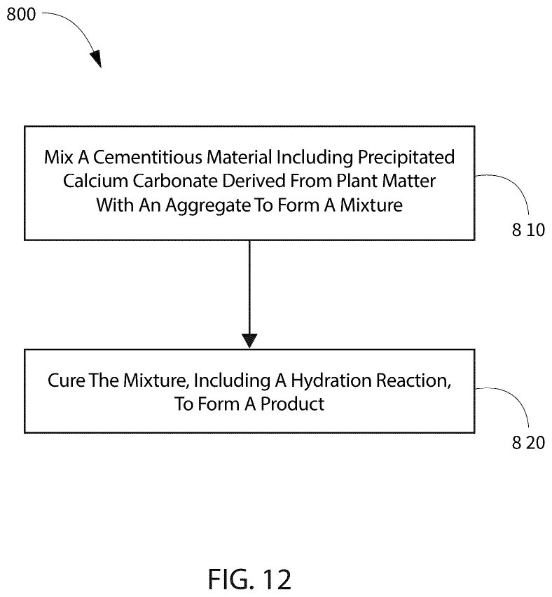

Turning now to FIG. 12, embodiments of the present disclosure may also include methods of preparing a product that includes cementitious material, such as the example method 800 illustrated in FIG. 12. As illustrated in FIG. 12, method 800 may include (810) mixing the cementitious material with an aggregate to form a mixture. The cementitious material includes precipitated calcium carbonate derived from plant matter, e.g., such as the example PCC described above. Method 800 may further include (820) curing the mixture. Curing the mixture may include permitting a hydration reaction, wherein the cementitious material reacts with water, to occur, such as for a period of time up to and including 28 days, or less, such as about seven days, or about one hour. The water may, for example, be water which is already present in the soil, e.g., when the product is soil cement, or the water may be added, such as when the product is concrete. As a result of the hydration reaction of the cementitious material with water, the product is formed. That is, the hydration reaction may result in the cementitious material forming a binder or substrate which encapsulates at least a portion of the aggregate, whereby the formed product includes a combination of the cement and one or more aggregates therein.

The precipitated calcium carbonate derived from plant matter may be obtained from a beet sugar manufacturing waste product, such as lime sludge which is settled, e.g., in a tank or pond from which the precipitate is then collected. For example, the precipitated calcium carbonate derived from plant matter may include a high proportion of calcium, such as between about 30% and about 60% calcium by weight.

In some embodiments, the product which is formed in method 800 may be, for example, a concrete. In such embodiments, the aggregate may include fine aggregate or coarse aggregate, where the terms “fine” and “coarse” are used with the meanings understood by those of ordinary skill in concrete arts and technology. For example, the aggregate may be or may include at least one of sand or gravel. In such embodiments, the method may further include adding water to the mixture.

In some embodiments, the product which is formed in method 800 may be, for example, a soil cement. In such embodiments, the aggregate may be soil. For example, the aggregate may be a silty soil or a loess soil type.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A concrete, comprising:
a cementitious material comprising a cement and precipitated calcium carbonate derived from plant matter;
water; and
an aggregate.

2. The concrete of claim 1, wherein the precipitated calcium carbonate comprises between about 30% and about 60% calcium by weight.

3. The concrete of claim 1, wherein the precipitated calcium carbonate comprises a powder or granular material having an irregular, sub-angular to sub-rounded morphology.

4. The concrete of claim 1, wherein the precipitated calcium carbonate derived from plant matter comprises about thirty percent of the cementitious material.

5. The concrete of claim 1, wherein the aggregate comprises upcycled concrete aggregate.

6. The concrete of claim 1, wherein the concrete has a twenty eight day compressive strength of at least four thousand pounds per square inch.

7. A soil cement, comprising:
soil; and
a cementitious material comprising precipitated calcium carbonate derived from plant matter.

8. The soil cement of claim 7, wherein the soil is a silty soil.

9. The soil cement of claim 7, wherein the soil is a loess soil.

10. The soil cement of claim 7, wherein the precipitated calcium carbonate comprises between about 30% and about 60% calcium by weight.

11. The soil cement of claim 7, wherein the precipitated calcium carbonate comprises a powder or granular material having an irregular, sub-angular to sub-rounded morphology.

12. The soil cement of claim 7, wherein the precipitated calcium carbonate derived from plant matter comprises 2.5% or more by dry-weight of the soil.

13. A method of preparing a product comprising cementitious material, the method comprising:
mixing the cementitious material with an aggregate to form a mixture, wherein the cementitious material comprises precipitated calcium carbonate derived from plant matter; and
curing the mixture, wherein curing the mixture comprises a hydration reaction of the cementitious material whereby the product is formed.

14. The method of claim 13, further comprising obtaining the precipitated calcium carbonate derived from plant matter from a beet sugar manufacturing waste product.

15. The method of claim 14, wherein the beet sugar manufacturing waste product comprises a lime sludge.

16. The method of claim 13, wherein the precipitated calcium carbonate comprises between about 30% and about 60% calcium by weight.

17. The method of claim 13, wherein the precipitated calcium carbonate comprises a powder or granular material having an irregular, sub-angular to sub-rounded morphology.

18. The method of claim 13, wherein the product comprises a concrete, wherein the aggregate comprises at least one of sand or gravel, and the method further comprising adding water to the mixture.

19. The method of claim 13, wherein the product comprises a soil cement, wherein the aggregate comprises a silty soil.
